(19) United States
(12) Patent Application Publication
(10) Pub. No.: US 2021/0045600 A1
(43) Pub. Date: Feb. 18, 2021

(54) Base Station for Stationary Emptying of a Dirt Space of a Mobile Cleaning Apparatus, Cleaning System and Method

(71) Applicant: Vorwerk & Co. Interholding GmbH, Wuppertal (DE)

(72) Inventors: Kevin Schmitz, Dusseldorf (DE); Hans-Peter Arnold, Kierspe (DE); Michael Körber, Aachen (DE)

(21) Appl. No.: 16/993,750

(22) Filed: Aug. 14, 2020

(30) Foreign Application Priority Data
Aug. 16, 2019 (DE) 10 2019 122 060.2

(51) Int. Cl. A47L 9/14; A47L 9/28; B65G 65/40

(52) U.S. Cl. CPC A47L 9/149; A47L 9/2805; A47L 9/2852; B65G 2201/04; A47L 2201/024; A47L 2201/022; A47L 2201/04; B65G 65/40

(57) ABSTRACT

The invention relates to a base station (10) for stationary emptying of a dirt space (41) of a mobile cleaning apparatus (40), comprising a dirt path (11) through which dirt can be transported out of the dirt space (41) of the cleaning apparatus (40), wherein a path input of the dirt path (11) is formed by a coupling element (12) which can be coupled to the cleaning apparatus (40) for emptying of the dirt space (41). Furthermore, the invention relates to a cleaning system (1) and a method (100) for stationary emptying of a dirt space (41) of a mobile cleaning apparatus (40).

The invention relates to a base station for stationary emptying of a dirt space of a mobile cleaning apparatus, a cleaning system and a method for stationary emptying of a dirt space of a mobile cleaning apparatus.

Suction robots and other automatic cleaning apparatuses are known from the prior art. These are used to automatically clean an area from dirt without the active intervention of a user. This allows the cleaning to be performed in the absence of the user, for example, so that the user is relieved of time. In order to be able to clean reliably even in narrow places, such as under furniture, suction robots are usually equipped with a small size. However, this has the disadvantage that the volume of the dirt space, in which the dirt is collected during the cleaning process, can often only be small. In order to enable further cleaning processes, the dirt space must therefore be emptied when its capacity for collecting dirt is reached.

However, since manual emptying, in particular, is time-consuming for the user, for suction robots, it is known, for example, to provide base stations at which the suction robot can empty the dirt space. For this purpose, these base stations usually have a collection space with a larger volume than the dirt space of the suction robot, so that several emptying processes of the suction robot are possible until an emptying of the base station by a user is requested. The docking process for emptying the suction robot is usually performed by the robot at known base stations, i.e. the suction robot navigates to a predetermined position. However, this navigation is often subject to inaccuracies in the range of a few millimeters to a few centimeters, so that several attempts may be necessary until the suction robot has reached the desired position. In addition, a certain starting power of the suction robot is usually required for starting for coupling, which exceeds the power otherwise required. Furthermore, the coupling is often realized by suction openings at the base station, which are permanently open. Furthermore, in contrast, it is also known that emptying openings on the suction robot are permanently open during the coupling with the base station, i.e. not only during emptying, but also, for example, during the loading phase. As a result, dust and/or smell can escape from the base station and be negatively perceived by a user.

It is an object of the present invention to at least partially remedy any disadvantages known from the prior art. In particular, it is an object of the present invention to simplify an emptying process of a mobile cleaning apparatus, preferably with improved user comfort, in particular by automation.

The above-mentioned object is solved by a base station with the features of claim 1, a cleaning system with the features of claim 16, and a method with the features of claim 19. Further features and details of the invention are given in the respective dependent claims, the description and the drawings. Features and details which are described in connection with the base station according to the invention are of course also valid in connection with the cleaning system according to the invention and/or the method according to the invention and vice versa. Thus, with regard to the disclosure of the individual aspects of the invention, reference is or can always be made to each other.

According to the invention, a base station for stationary emptying of a dirt space of a mobile cleaning apparatus is provided. The base station comprises a dirt path through which dirt can be transported from the dirt space of the cleaning apparatus preferably to the base station. A path input of the dirt path is formed by a coupling element which can be coupled to the cleaning apparatus for emptying the dirt space. Furthermore, according to the invention, it is provided that the base station comprises a drive unit by means of which the coupling element can be moved from a rest position, in which emptying of the dirt space via the coupling element is prevented, into a coupling position, in which the coupling element is arranged, in particular directly, on the cleaning apparatus, so that emptying of the dirt space via the coupling element (to the base station) is enabled.

The mobile cleaning apparatus can preferably be an autonomously working, mobile cleaning apparatus, which advantageously performs its core work (such as vacuuming, wiping and/or cleaning) independently without human assistance. The mobile cleaning apparatus may in particular be a suction robot. However, it is also conceivable that the mobile cleaning apparatus is a manually operated vacuum cleaner, a wiping robot or another cleaning apparatus. In particular, the cleaning station may be suitable for stationary emptying of different mobile cleaning apparatuses. Stationary emptying can preferably be understood to imply that the base station is stationary. Thus, the base station can be a starting point for the navigation of the mobile cleaning apparatus. To enable stationary emptying, it may be provided that the base station has a suction unit, e.g. in the form of a fan or pump, through which the dirt can be sucked out of the dirt space of the mobile cleaning apparatus. In addition or alternatively, the mobile cleaning apparatus may have a blow-out unit through which the dirt can be conveyed from the dirt space into the dirt path of the base station.

The dirt path can preferably have pipes and/or lines through which the dirt can be transported when emptying the dirt space of the mobile cleaning apparatus. Furthermore, the cleaning station can have a collection space for collecting dirt from several cleaning processes of the cleaning apparatus. Preferably, the dirt path can lead into the collection space. The collection space can, for example, have a collection bag which can be replaced by the user when emptying the collection space. The coupling element can form a subsection of the dirt path. It is therefore conceivable that the dirt path is formed by a rigid line on which the coupling element is arranged, in particular fixed. However, it is also conceivable that the coupling element forms a section of a one-piece, in particular flexible, line which forms the dirt path. At the path input in the form of the coupling element, dirt may be allowed to enter the dirt path and/or the base station. For this purpose, the coupling element may have an input opening. In particular, the coupling element can be a suction nozzle. To move the coupling element, at least the coupling element can be hinged in a movable way and connected to the drive unit. For moving the coupling element, the drive unit may have, for example, an electric motor, a compressed air-driven drive or the like.

By emptying the dirt space via the coupling element it can be understood that the dirt passes the coupling element when emptying the dirt space, in particular it is transported through the coupling element. In particular, a fluid communication connection of the coupling element, and preferably of the collection space, with the dirt space can be enabled in the coupling position. Preferably, the coupling element can therefore be designed as a line, in particular as a pipe. The fact that the coupling element is arranged on the cleaning apparatus in the coupling position may preferably involve the coupling element contacting the cleaning apparatus. However, it is also conceivable that the coupling element is at least partially immersed in the cleaning apparatus in the coupling position, in order to enable dirt to be removed from the dirt space of the cleaning apparatus. Preferably, the coupling position can be reached and/or recognized by path control and/or force control.

Thus, the power of action for emptying the dirt space of the mobile cleaning apparatus lies in particular with the base station according to the invention. Because the coupling element is adjustable to the cleaning apparatus until the coupling position is reached, tolerances in the navigation of the cleaning apparatus can be compensated without the cleaning apparatus itself being aligned. In this way, a self-propelled cleaning apparatus can avoid situations in which the cleaning apparatus tries to find the correct positioning and requires several attempts over a period of time. The coupling can also be interrupted when the emptying of the dirt space is completed. This allows the cleaning apparatus to remain in the base station before or after the emptying, for example in order to be charged, without a fluid communication connection between the dirt space and a user's living room and/or the collection space of the base station.

Preferably, in the case of a base station according to the invention, it may be provided that the drive unit is designed to move the coupling element from the rest position until the coupling element is placed in the coupling position on the cleaning apparatus, in particular vertically, in particular if the cleaning apparatus is positioned in a docking area. The docking area can preferably be understood as an area in which the cleaning apparatus can be positioned in order to enable coupling with the base station. Preferably, this may also allow a charging of a battery of the cleaning apparatus. The docking area can be formed, for example, by a housing of the base station. Furthermore, it is conceivable that the docking area comprises an area in front of or on the base station. In particular, the docking area can also be unstructured. The fact that the coupling element is placed on the cleaning apparatus in the coupling position can be understood in particular to mean that the coupling element contacts the cleaning apparatus, preferably hitting an emptying interface of the cleaning apparatus. The emptying interface can be provided at a lateral, lower and/or upper outer surface of the cleaning apparatus. The drive unit is preferably designed to move the coupling element at least partially in a vertical movement until the coupling element is placed on the cleaning apparatus. This allows the coupling element to be placed on the cleaning apparatus from above in relation to a ground. In this way, an interface on the cleaning apparatus can be used for stationary emptying, for example, which can also be conveniently reached with a manual vacuum cleaner to enable manual emptying.

Preferably, in the case of a base station according to the invention, it may be provided that the drive unit has a detection device for recognizing the coupling position, in particular wherein the detection device has an electronic detection module and/or a force sensor. The detection device can be used to recognize a touch, in particular a placement, of the coupling element on the cleaning apparatus. For this purpose, the detection device can preferably measure a current which is applied by the drive unit to drive the coupling element. If there is a predetermined current increase or a predetermined current, it can be concluded that the coupling element is moved against an object, i.e. the cleaning apparatus, and is consequently in the coupling position. In particular, a force on the coupling element can be measured as a result. The current increase can be recognized by the detection module. The detection module is preferably part of a control unit of the base station. When the coupling position is recognized, the control unit can finally start emptying the dirt space, in particular by suction.

Furthermore, in a base station according to the invention, it is conceivable that a coupling lock is provided by which the coupling element can be at least partially locked in the rest position, in particular wherein the coupling lock is designed to be immovable and the coupling element can be moved by the drive unit from the coupling position to the coupling lock. Fluid communication of the dust path and/or the collection space of the base station with an outside area, in particular a room or the like, can be prevented by the coupling lock. This prevents the possible release of negative smells due to absorbed dirt. Preferably, the coupling lock may have a stop surface on which the coupling element is placed in the rest position. The stop surface can be at least partially elastic to provide a sealing effect at the edge of the coupling element. An immovable coupling lock can thus enable the base station to be designed in a simple and cost-effective manner. Furthermore, the coupling lock can define the rest position. In particular, the detection device for recognizing the coupling position can also be designed to recognize the rest position. Additionally or alternatively, the coupling lock can be provided as a closure panel on the coupling element which is closed in the rest position. For this purpose, a spring element may be provided which keeps the coupling lock closed at least in the rest position.

Preferably with a base station according to the invention, it can be provided that the drive unit comprises a holding element by which the movement of the coupling element can be limited if the coupling position remains unreached after a predetermined movement of the coupling element. Preferably, the holding element can comprise an electrical switch by which an end position can be recognized if the coupling position is not reached. Thus, it can be provided that in the case of a cleaning apparatus positioned in the docking area, this apparatus serves as a stop for the coupling element, whereby the coupling position is also recognized, and in the case of an empty docking area, the end position can be recognized via the electrical switch. In particular, a movement path of the coupling element until reaching the holding element is larger than until reaching the coupling position. If the coupling position is not reached, a control unit of the base station can, for example, inform the cleaning apparatus by sending a signal that a repositioning of the cleaning apparatus is necessary.

Furthermore, in the case of a base station according to the invention, it is conceivable that the drive unit has a link guide through which the coupling element can be guided from the rest position to the coupling position. The link guide allows the coupling element to be guided from the rest position to the coupling position in a cost-effective manner. In particular, a reliable and reproducible sequence of movement can be specified by the link guide. For example, in combination with one or more linear drives and/or a lever gear, a sequence of movements of the coupling element can be enabled by which further functions can be implemented. It is conceivable, that the sequence of movements can be used to first open a closing element of the cleaning apparatus by the coupling element and then reach the coupling position. The link guide can preferably be designed in the form of a rail and/or comprise a recess in which a guide element of the coupling element is in particular movably mounted.

Furthermore, in the case of a base station according to the invention, it can be advantageously provided that the drive unit comprises at least one linear drive for linear movement of the coupling element and/or at least one swivel drive for performing a swiveling movement of the coupling element. Thus, a sequence of movement with a linear movement and/or a swiveling movement can be enabled by the drive unit in a reliable manner. Several linear drives and/or several swivel drives can also be provided. The linear drive and/or the swivel drive can preferably comprise an electric motor, a pneumatic and/or a hydraulic drive. Thus, the movement of the coupling element can be controlled and/or monitored by a control unit with high accuracy. The detection device for recognizing the coupling position can be integrated into the linear drive and/or the swivel drive, especially if a current of the drive unit for recognizing the coupling position can be measured by the detection device. Furthermore, preferably the holding element may comprise an internal end stop of the linear drive and/or the swivel drive for limiting the movement of the coupling element.

Furthermore, in the case of a base station according to the invention, it may be advantageously provided that the drive unit comprises a lever gear through which the coupling element can be moved from the rest position to the coupling position, By means of the lever gear, a sequence of movement with a linear movement and/or a swiveling movement in the drive unit can be enabled. The lever gear can be combined with a link guide, a linear drive and/or a swivel drive. Preferably, the lever gear comprises several lever elements which are hinged together to enable one or more movement sections of a sequence of movement of the coupling element from the rest position to the coupling position. In particular, the lever gear can also be described as a multiple hinged gear. The individual lever elements can be manufactured at low cost, for example from stamped parts, with high tolerance specifications and at the same time reliable operation of the base station can be ensured.

Furthermore, in the case of a base station according to the invention, it may be advantageous to provide a housing element through which a docking area is formed in which the cleaning apparatus can be positioned to enable coupling with the coupling element. Thus, a slot can be formed by the housing element in which the cleaning apparatus can be received. The cleaning apparatus can be at least partially guided into the docking area through the housing element. Thus, it is conceivable that the housing element has guide elements through which the cleaning apparatus can be given a movement path. Furthermore, it can be possible that the docking area can be found more easily by the cleaning apparatus. Preferably, the base station can also comprise a charging device for electrically charging the cleaning apparatus, in particular a battery of the cleaning apparatus. The charging device can be integrated into the housing element so that the electrical charging of the cleaning apparatus can be enabled in the docking area.

Furthermore, in the case of a base station according to the invention, it is conceivable that the coupling element is arranged in such a way that, when the base station is used as intended, the coupling element is placed on an upper surface of the cleaning apparatus in the coupling position. During intended use, it may be provided that the base station is arranged on a ground, such as a floor, and/or is integrated into a piece of furniture. When used as intended, the upper surface of the cleaning apparatus thus corresponds in particular to an outside surface of the cleaning apparatus that is parallel or essentially parallel to the ground. Thus, an emptying interface of the cleaning apparatus can be used by the base station, which can also be conveniently used for manual emptying. Furthermore, the coupling position can be defined advantageously by the coupling element hitting the cleaning apparatus from above. Thus, the cleaning apparatus offers in particular a resistance against the movement of the coupling element without the cleaning apparatus being displaced during coupling with the coupling element. Furthermore, this allows the emptying interface to be arranged at the top surface of the cleaning apparatus and the bottom of the cleaning apparatus to be available for further functions, such as brushes etc. This improves the design freedom of the cleaning apparatus in favour of user comfort.

Furthermore, in a base station according to the invention, it can be advantageously provided that the coupling element comprises a counter stop surface with which the coupling element can be placed in the coupling position on a stop surface of the cleaning apparatus, in particular wherein the counter stop surface comprises a flexible material for sealing between the stop surface and the counter stop surface. The flexible material may comprise an elastomer, for example. This means that when the coupling element is placed on the stop face of the cleaning apparatus, automatic sealing can be enabled so that the escape of dirt and/or smells during emptying can be prevented. Furthermore, the flexible material can also prevent damage to the coupling element and/or the cleaning apparatus when the coupling element is moved into the coupling position. In particular, the counter stop surface can be designed to correspond to the stop surface, so that the coupling in the coupling position is favoured. Preferably, the counter stop surface comprises a, in particular flat, edge of the path input on the coupling element.

Preferably, in the case of a base station according to the invention, it may be provided that the drive unit is designed to move the coupling element from the rest position to the coupling position in a sequence of movement with at least two movement sections which differ at least partially in a direction of movement of the coupling element. Preferably, one of the movement sections may comprise a swiveling movement of the coupling element and one of the movement sections may comprise a linear movement of the coupling element. The sequence of movement can thus enable the coupling element to be moved from the rest position to the coupling position and vice versa in a small installation space. In particular, the coupling element can be advantageously moved away from a coupling lock without requiring a large space for horizontal or vertical movement. Consequently, the base station may require only a small overall installation space and thus be advantageously integrated into a piece of furniture and/or take up only a small amount of space in a user's home. This can improve the user's living comfort.

Furthermore, in the case of a base station according to the invention, it can be advantageously provided that the drive unit is designed to open an emptying interface of the cleaning apparatus in a first movement section of the coupling element and to move the coupling element in the direction of the emptying interface in a second movement section, in particular wherein in the second movement section the counter stop surface of the coupling element can be pressed onto the stop surface of the cleaning apparatus. The opening of the emptying interface can be realized, for example, by a swiveling movement in which a closing element is pushed into an opening position. Alternatively, the closing element can be pushed open by a linear movement, e.g. if it is mounted in a swiveling manner. The coupling element can be used to exert a force on the emptying interface, in particular the closing element of the emptying interface, preferably in the first movement section. The detection device can preferably be designed to distinguish between the coupling element reaching the coupling position and the opening of the emptying interface.

Furthermore, in the case of a base station according to the invention, it may be advantageously provided that the drive unit has a feedback element by means of which the coupling element in the coupling position is preloaded into the rest position and/or an intermediate position. The feedback element may comprise a spring element, in particular in the form of a wire spring and/or a self-relieving spring. In particular, the coupling element may comprise a bearing pin which is mounted in a U-shaped slot of the feedback element. The bearing pin may also be connected to the spring element. The sequence of movement of the coupling element can be predetermined by the drive unit in such a way that the bearing pin is lifted out of the slot of the feedback element when the coupling element is adjusted into the coupling position. The spring element can be loaded into the intermediate position or the rest position. This prevents the coupling element from remaining in the coupling position in case of a malfunction of the drive. In this way, damage to the coupling element and/or the cleaning element can be avoided, e.g. even if the cleaning element leaves the docking area during malfunction. In addition, the feedback element can enable a pressing onto the coupling lock when the coupling element is preloaded in the rest position. This can ensure a reliable seal in the rest position.

Preferably, the coupling element can be rotatably mounted on a bearing element, in particular in a U-shaped slot of the feedback element, and can comprise a circular arc-shaped sealing contour which enables sealing of the dust path when the coupling element is rotated around the bearing element. In this way a movable coupling element can be created in a simple manner, which allows a rotating movement in a small installation space, in particular without the dust path losing a seal as a result of the movement in the area of two parts moving relative to each other. Due to the U-shaped slot, a second movement section can be enabled by lifting the bearing element out of a seat in the U-shaped slot. Finally, the lifting can be reset by the feedback element. Preferably, the dust path comprises flexible materials in the area of the sealing contour. The bearing element can also be provided with a sealing lip that is compressed when the coupling element is rotated, so that a sealing effect is maintained at the bearing point when the coupling element is moved. The rotation around the bearing element can be realized by a linear drive.

According to another aspect of the invention, a cleaning system is claimed. The cleaning system comprises a mobile cleaning apparatus, in particular a cleaning robot, comprising a dirt space for receiving dirt during a cleaning process of the cleaning apparatus, and a base station, in particular a base station according to the invention, for stationary emptying of the dirt space of the cleaning apparatus. The base station comprises a dirt path through which dirt can be transported out of the cleaning apparatus. A path input of the dirt path is formed by a coupling element which can be coupled to the cleaning apparatus for emptying the dirt space. According to the invention, it is further provided that the base station comprises a drive unit by means of which the coupling element can be moved from a rest position, in which emptying of the dirt space via the coupling element is prevented, into a coupling position, in which the coupling element is arranged, in particular directly, on the cleaning apparatus, so that emptying of the dirt space via the coupling element is enabled.

Thus, a cleaning system according to the invention has the same advantages as those already described in detail with regard to a base station according to the invention. Preferably, the dirt space can be carried along when the cleaning apparatus is moved. A cleaning robot can be understood in particular as a mobile cleaning apparatus that cleans automatically, preferably in the form of a suction robot or a wiping robot. By using the cleaning robot with the base station, the effort required for a user to dispose of the dirt can be reduced. When using a manual cleaning apparatus, for example, dust bags in the cleaning apparatus can be omitted and at the same time an allergy-friendly emptying of the cleaning apparatus can be enabled in which dirt does not escape from the cleaning apparatus and/or the base station. In particular, the cleaning system may allow a higher tolerance for the positioning of the cleaning apparatus so that user comfort can be increased and/or navigation inaccuracies of the cleaning element can be compensated.

In particular, another aspect of the invention may lie in a mobile cleaning apparatus. In particular, the cleaning apparatus may be a cleaning robot. Furthermore, the cleaning apparatus may comprise a dirt space for receiving dirt during a cleaning process of the cleaning apparatus and an emptying interface which is designed for coupling to a base station, preferably a base station according to the invention. In particular, the emptying interface is designed for stationary emptying of the dirt space by the base station, in particular by a coupling element of the base station. For this purpose, the emptying interface can have an emptying opening through which the coupling element of the base station can be brought into a fluid communication connection, in particular one that is sealed from the outside, with the dirt space. The emptying interface can also be designed for passive coupling with the coupling element of the base station. Passive coupling can be understood to imply that the emptying opening remains motionless or essentially motionless when the coupling is established. Thus, an inventive cleaning apparatus comprises the same advantages as those already described in detail with respect to a base station and/or a cleaning system according to the invention.

Preferably, in the case of a cleaning system according to the invention and/or a cleaning apparatus according to the invention, it can be provided that the cleaning apparatus comprises an emptying interface with a stop surface in which an emptying opening is formed so that the coupling element of the base station can be placed on the stop surface, in particular wherein the stop surface comprises a flexible material for sealing between the stop surface and the counter stop surface. The flexible material can advantageously comprise an elastomer. In this way, sealing can be enabled in a simple manner. The sealing can prevent the escape of smells and/or dirt. In particular, the stop surface can create a tolerance range in which a coupling of the coupling element with the emptying interface can be enabled.

Furthermore, in the case of a cleaning system according to the invention and; or a cleaning apparatus according to the invention, it is conceivable that the cleaning apparatus comprises a closing element for closing the emptying interface, wherein the closing element can be moved from a closing position, in which the emptying interface is at least partially closed by the closing element, into an opening position, in which the coupling element can be brought into fluid communication connection with the dirt space of the cleaning apparatus, in particular wherein the closing element is preloaded into the closing position. In the closing position, the closing element can in particular close an emptying opening of the cleaning apparatus. In the opening position, the closing element can release the emptying opening. It is therefore not necessary for the emptying opening to be permanently open. This can prevent dirt and/or smells from escaping from the cleaning apparatus. Due to the sequence of movement of the coupling element, the drive unit can directly or indirectly cause the closing element to open. For preloading in the closing position, the closing element may have a closing spring and/or be of elastic design. Thus, an electronic control of the closing element is not necessary. In particular, the entire emptying process can be carried out by the base station, i.e. in particular without interaction of the cleaning apparatus, if the cleaning apparatus is located in the docking area of the base station.

According to another aspect of the invention, a method for stationary emptying of a dirt space of a mobile cleaning apparatus, in particular in a cleaning system according to the invention, is claimed. The method comprises the following steps:
Positioning of the cleaning apparatus at a base station, in particular a base station according to the invention, preferably wherein the positioning is effected by an automatic navigation of the cleaning apparatus,
Moving a coupling element from a rest position, in which fluid communication connection of the coupling element with the cleaning apparatus is prevented, to a coupling position, in which the coupling element is arranged on the cleaning apparatus, so that emptying of the dirt space via the coupling element is enabled,
Removing of dirt from the dirt space of the cleaning apparatus, in particular for emptying the dirt space, via the coupling element, in particular by the base station.

Thus, a method according to the invention comprises the same advantages as those already described in detail with respect to a base station and/or cleaning system according to the invention. The movement of the coupling element is preferably realized by a drive unit of the base station. When removing the dirt from the dirt space of the cleaning apparatus, the dirt can be in particular sucked off, e.g. by a fan of the base station. In particular, all steps of the method can be automated. This can reduce the user's effort.

Furthermore, in a method according to the invention, it can be advantageously provided that the cleaning apparatus is positioned in a docking area during positioning and the movement of the coupling element takes place until the coupling element is placed on the cleaning apparatus in the coupling position. Thus the cleaning apparatus can serve as a stop for the coupling element. Preferably, the cleaning apparatus can be recognized in the docking area, especially by a control unit of the base station and/or the cleaning apparatus, Following the recognizing of the cleaning apparatus in the docking area, the coupling element can then be moved. This ensures that a coupling is enabled when the coupling element is moved.

Preferably, in a method according to the invention, it may be provided that the movement of the coupling element from the rest position into the coupling position comprises a sequence of movement with at least two movement sections which differ at least partially in a direction of movement of the coupling element. As a result, an intermediate position can be reached by the coupling element, in which switching over the directions of movement is possible in a simple manner. Furthermore, this can result in a small space for movement of the coupling element, which in particular defines the required installation space. This allows a compact design of the base station. Furthermore, it may be easier to place the coupling element on the cleaning apparatus by dividing the movement into the movement sections.

Preferably, a method according to the invention may provide that when the coupling element is moved, in a first movement section of the coupling element an emptying interface of the cleaning apparatus is opened and in a second movement section the coupling element is moved in the direction of the emptying interface. Thus, different functions can be performed by the sequence of movement, which can be linked in a simple manner. This makes automated coupling between the coupling element and the emptying interface particularly easy.

Furthermore, in a method according to the invention, it is conceivable that the sequence of movement comprises at least one linear movement and/or at least one swiveling movement. Thus a small installation space can be used for the movement in a simple manner. A combination of a swiveling movement and a linear movement is an advantageous way of realizing a sequence of movement for the functions described above.

Further advantages, features and details of the invention are given in the following description, in which, with reference to the figures, embodiments of the invention are described in detail. The features mentioned in the claims and in the description may be individually or in any combination substantially inventive. The figures show schematically:

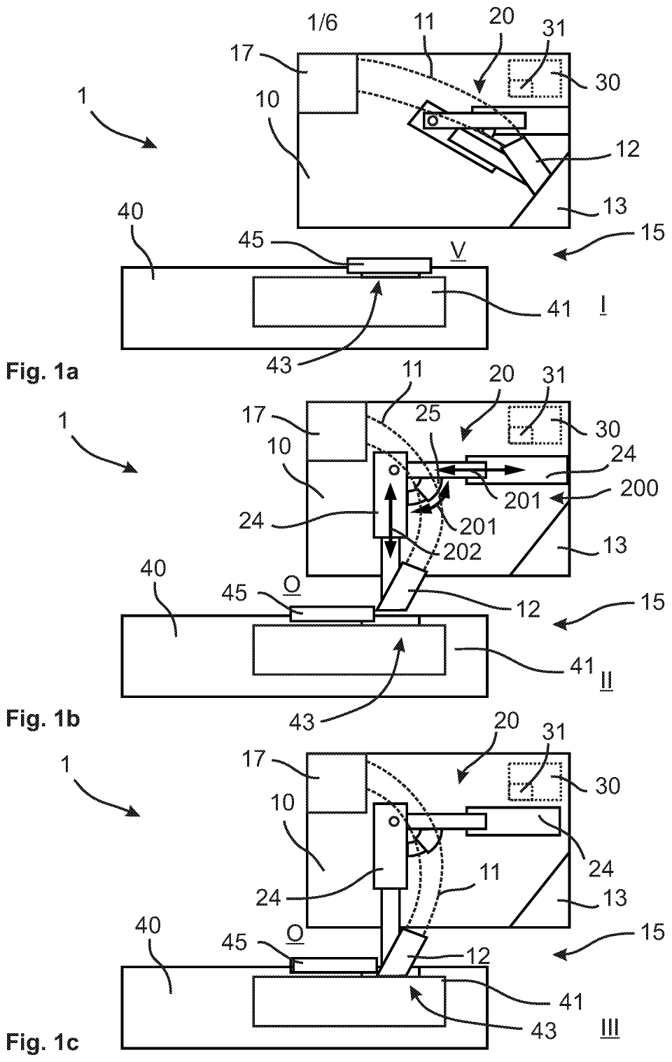

FIGS. 1a to 1c a sequence of movement of a coupling element in a cleaning system according to the invention in a first embodiment,

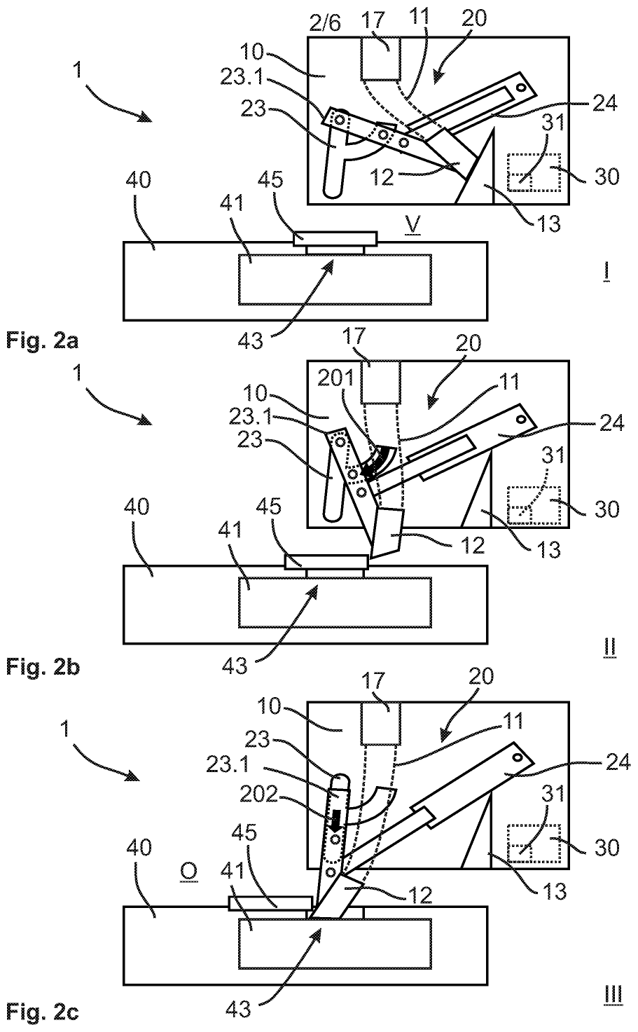

FIGS. 2a to 2c a sequence of movement of a coupling element in a cleaning system according to the invention in a second embodiment,

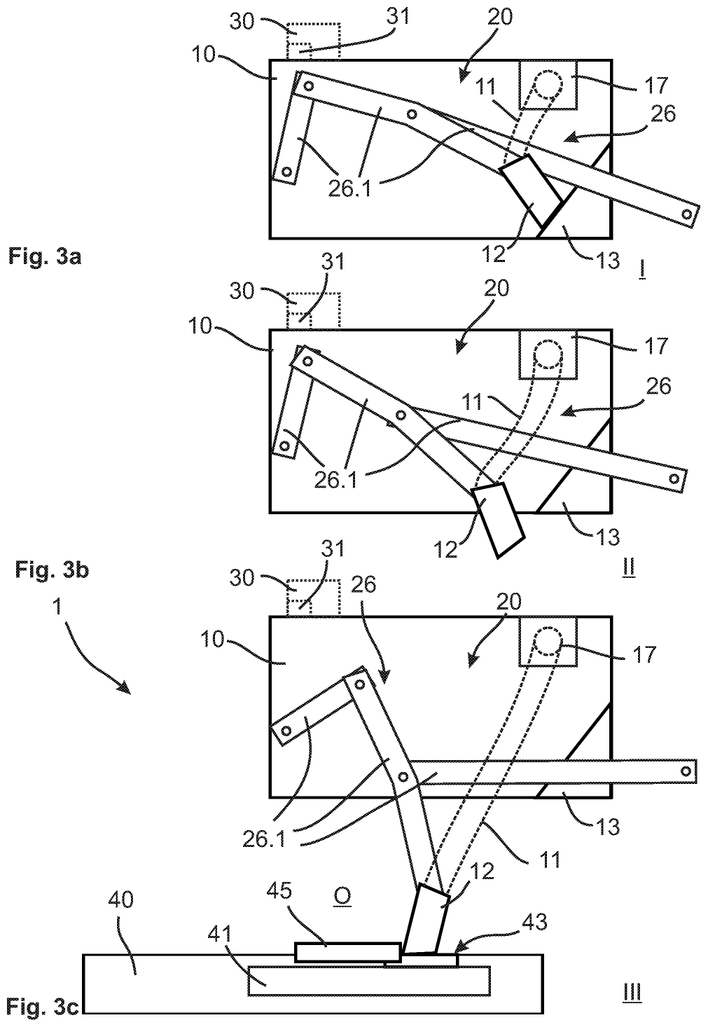

FIGS. 3a to 3c a sequence of movement of a coupling element in a cleaning system according to the invention in a third embodiment,

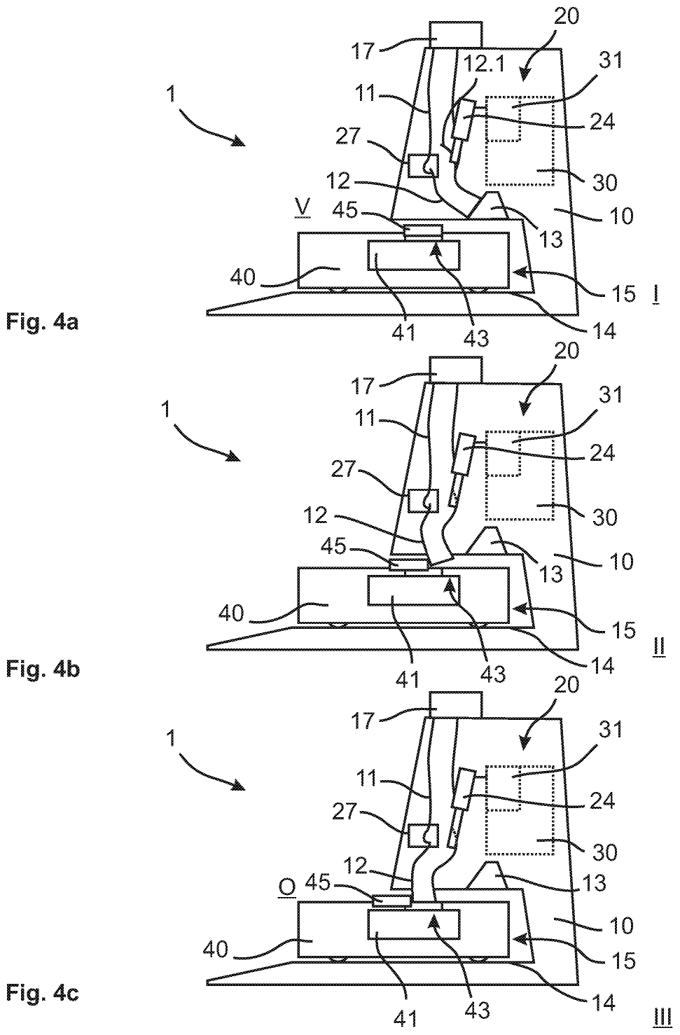

FIGS. 4a to 4c a sequence of movement of a coupling element in a cleaning system according to the invention in a fourth embodiment,

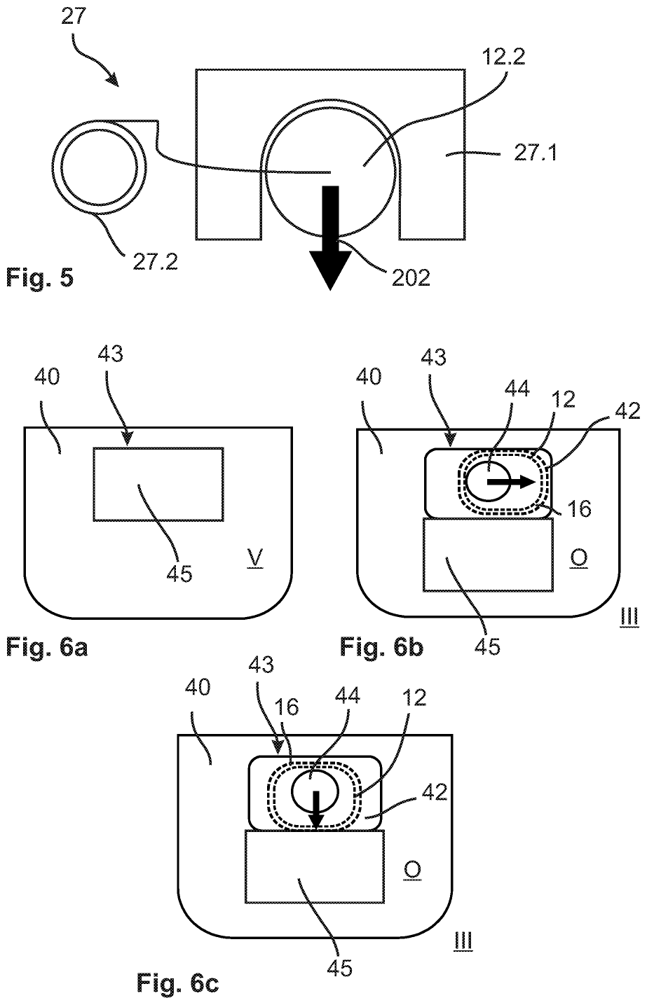

FIG. 5 a reset element of the cleaning system of the fourth embodiment,

FIGS. 6a to 6c a cleaning apparatus of a cleaning system according to the invention,

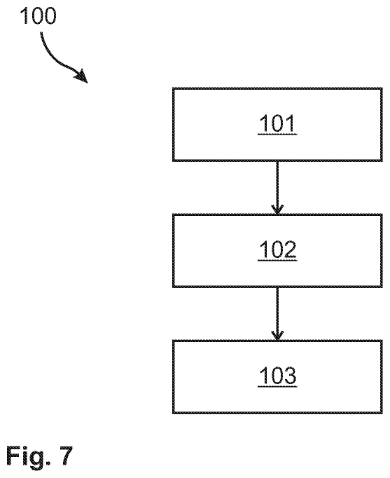

FIG. 7 a method according to the invention in a schematic representation of the method steps in a further embodiment.

In the following description of some embodiments of the invention, identical reference signs are used for the same technical features even in different embodiments.

FIGS. 1a to 1c show a cleaning system 1 according to the invention in a first embodiment. Here, the cleaning system 1 comprises a mobile cleaning apparatus 40, which is positioned in a docking area 15 of a base station 10 of cleaning system 1 according to the invention for stationary emptying of a dirt space 41 of the cleaning apparatus 40. The cleaning apparatus 40 is preferably a cleaning robot, in particular in the form of a suction robot. The dirt space 41 can be designed to collect dirt during a mobile cleaning process of the cleaning apparatus 40. When the dirt space 41 is emptied, dirt is sucked off, in particular via a dust path 11 of the base station 10, and transported to a central collection space 17. Advantageously, the collection space 17 can have a larger volume than the dirt space 41. This means that the dirt space 41 can be emptied several times into the collection space 17 until a manual emptying of the collection space 17 by a user is necessary. This may improve user comfort and/or reduce the time required for maintenance of the cleaning system 1.

In order to enable the dirt space 41 to be emptied when the cleaning apparatus 40 is in the docking area 15, the base station 10 comprises a drive unit 20, through which a coupling element 12 can be moved from a rest position I to a coupling position III. The coupling element 12 thereby forms a path input of the dust path 11, so that a fluid communication connection of the dirt space 41 of the cleaning apparatus 40 with the collection space 17 of the base station 10 can be established via the coupling element 12 when the coupling element 12 is located in the coupling position III.

The rest position I is shown in FIG. 1a. In the rest position I, the emptying of the dirt space 41 via the coupling element 12 is prevented, especially since a fluid communication connection between the dust path 11 and the dirt space 41 is interrupted. The coupling element 12 is placed on a coupling lock 13, which is rigid and immovable. In the rest position I, the coupling lock 13 prevents dirt and/or smells from escaping from the collection space 17 via the coupling element 12. An emptying interface 43 of the cleaning apparatus 40 is further closed by a closing element 45, which is in a closing position V. This also prevents dirt and/or smells from escaping from the dirt space 41.

The drive unit 20 allows a sequence of movement 200 to be performed by the coupling element 12. In at least one first movement section 201 of the sequence of movement 200, the coupling element 12 is moved to an intermediate position II. The first movement section 201 comprises in particular a linear movement and a swiveling movement. During the movement of the first movement section 201, the coupling element 12 moves the closing element 45 of the cleaning apparatus 40 from the closing position V to an opening position O. For this purpose, the coupling element 12 can press against the closing element 45 and thus overcome a pretension of the closing element 45 in the closing position V. Preferably, the dust path 11 comprises a flexible line, in particular in the form of a hose, which is connected to the coupling element 12 and the collection space 17.

From the intermediate position II, the drive unit 20 enables a second movement section 202 of the sequence of movement 200 of the coupling element 12, in which the coupling element 12 can be moved into the coupling position Ill. In doing so, the coupling element 12 is placed vertically from above onto the cleaning apparatus 40 when the base station 10 is used as intended, as shown. The coupling position III, in which the coupling element 12 is arranged on the cleaning apparatus 40, is shown in FIG. 1c. In the coupling position Ill, this allows the emptying of the dirt space 41 via the coupling element 12 is enabled by establishing a fluid communication connection between the dirt space 41 and the dirt path 11 and/or the collection space 17 of the base station 10 via the coupling element 12. During the second movement section 202 from the intermediate position II to the coupling position III, the coupling position III is reached in particular when the coupling element 12 is placed on the cleaning apparatus 40.

To enable the sequence of movement 200, the drive unit 20 as shown in FIG. 1b comprises two linear drives 24 and a swiveling drive 25. The linear drives 24 and the swiveling drive 25 can each comprise an electric motor or be controlled pneumatically. Alternatively, the swiveling drive 25, for example, can also be implemented using a lever gear 26. In order to recognize the coupling position Ill, the base station 10 also comprises a control unit 30 which has a detection device 31 in the form of an electronic detection module. In addition or alternatively, the detection device 31 may comprise a force and/or current sensor to recognize the coupling position Ill. In particular, the electronic detection module can evaluate a current consumption of the linear drive 24 for the execution of the second movement section 202. An increase and/or an exceeding of a predetermined current limit can refer to the coupling position Ill being reached by placing the coupling element 12 on the cleaning apparatus 40.

FIGS. 2a to 2c show a cleaning system 1 according to the invention in a second embodiment. The cleaning system 1 of the second embodiment essentially corresponds to the cleaning system 1 of the first embodiment. A coupling element 12 of an inventive base station 10 of the cleaning system 1 can be moved from a rest position I shown in FIG. 2a to an intermediate position II and a coupling position Ill shown in FIGS. 2b and 2c, A drive unit 20 is provided to enable the first and second movement sections 201, 202 for moving the coupling element 12 to the coupling position III. In the second embodiment, however, the drive unit 20 has only one linear drive 24, through which a hinged guide element 23.1 connected to coupling element 12 can be moved. Furthermore, the guide element 23.1 is hingedly mounted in a link guide 23 of the drive unit 20, through which the coupling element 12 can be guided to carry out the movements of the first and second movement sections 201, 202. In particular, it may be provided that the first movement section 201 merges smoothly into the second movement section 202, so that the intermediate position II is only passed through without the coupling element 12 stopping. The link guide 23 can also be used to enable a closing element 45 of the cleaning apparatus 40 to be moved.

In FIGS. 3a to 3c, an inventive base station 10 of an inventive cleaning system 1 is shown in a third embodiment, the cleaning system 1 being substantially the same as the cleaning system 1 of the first embodiment. For a better overview, a mobile cleaning apparatus 40 of the cleaning system 1 is only shown in FIG. 3c, in which a coupling element 12 of a base station 10 of the cleaning system 1 is located in the coupling position III. FIG. 3a shows the coupling element 12 in a rest position I, in which the coupling element 12 is placed on a coupling lock 13 and is thus closed. FIG. 3b shows an intermediate position II which is passed through by the coupling element 12 when the coupling element 12 is moved from the rest position I to the coupling position III. The coupling element 12 is moved by a drive unit 20 in a combined linear and swiveling movement. The combined linear and swiveling movement is guided by a lever gear 26 of the drive unit 20. For this purpose, the lever gear 26 has several lever elements 26.1, which are hinged to each other and directly or indirectly connected to the coupling element 12. When the coupling element 12 is moved, a closing element 45 of the cleaning apparatus 40 can be transferred to an opening position.

FIGS. 4a to 4c also show a cleaning system 1 according to the invention in a fourth embodiment, which essentially corresponds to the cleaning system 1 of the first embodiment. In the fourth embodiment, a drive unit 20 of a base station 10 comprises a linear drive 24 by which a coupling element 12 can be moved from a rest position I to a coupling position III. For this purpose, the linear drive 24 is operatively connected to the coupling element 12. Furthermore, the coupling element 12 has a bearing element 12.2 which is rotatably mounted in a U-shaped slot 27.1 of a feedback element 27. The bearing of the coupling element 12 with the feedback element 27 is shown in more detail in FIG. 5. When the linear drive 24 is moved, the coupling element 12 thus rotates in the U-shaped slot 27.1 up to the intermediate position II. In order to continue to enable sealing of the dust path 11, the coupling element 12 has a circular arc-shaped sealing contour 12.1, which is sealingly guided on a rigid section of the dust path 11. In the intermediate position II, the bearing element 12.2 is at least partially lifted out of its seat in the U-shaped slot 27.1 in a second movement section 202 so that a linear movement in the direction of the coupling position III takes place until the cleaning apparatus 40 is reached and the coupling element 12 is placed on the cleaning apparatus 40. A spring element 27.2 counteracts the lifting out of the bearing element 12.2 so that the coupling element 12 is moved out of the coupling position III in case of a malfunction of the drive unit 20. FIGS. 4a to 4c also show a docking area 15 for positioning the cleaning apparatus 40, which is formed by a housing element 14 of the base station 10. Thus the docking area 15 can be structurally predetermined by the housing element 14, so that the cleaning apparatus 40 can more easily navigate or be guided into a tolerance range for the coupling position III.

FIGS. 6a to 6c show a top view of an upper side of a cleaning apparatus 40 with an emptying interface 43, to which a coupling element 12 can be coupled in a coupling position III for stationary emptying of a dirt space 41 of the cleaning apparatus 40. In particular, the cleaning apparatus 40 of the preceding embodiments may be designed in accordance with the embodiment of FIGS. 6a to 6c. In this case a closing element 45 as shown in FIG. 6a is in a closing position V in which an emptying opening 44 of the emptying interface 43 is closed by the closing element 45 to prevent the escape of dirt and/or smells. In FIGS. 6b and 6c the closing element 45 is in an opening position O, in which an emptying opening 44 is released by the closing element 45, This allows a coupling element 12 to be placed in fluid communication connection with the emptying opening 44, for example to allow the dirt space 41 to be sucked out. A stop surface 42 is formed around the emptying opening 44, onto which a counter stop surface 16 of the coupling element 12 can be placed. The stop surface 42 forms a tolerance range in which the counter stop surface 16 of the coupling element 12 can be placed offset to the emptying opening 44, so that a sealing effect between the stop surface 42 and the counter stop surface 16 is possible. Preferably, the coupling element 12 has a larger diameter than the emptying opening 44. Furthermore, the coupling element 12 can have a flexible material at least at the counter stop face 16 and/or the cleaning apparatus 40 at the stop face 42 in order to increase the sealing effect. When placing the counter stop surface 16 on the stop surface 42, a detection device 31 can in particular recognize that the coupling element 12 has reached the coupling position III.

FIG. 7 also shows a method 100 according to the invention for the stationary emptying of a dirt space 41 of a mobile cleaning apparatus 40 in a schematic representation of method steps. Preferably, the method 100 can be carried out by a cleaning system 1, in particular a control unit of the cleaning system 1, according to one of the preceding embodiments. The method 100 comprises a positioning 101 of the cleaning apparatus 40 at a base station 10. For this purpose the cleaning apparatus 40 can preferably be moved automatically into a docking area 15. Furthermore, a moving 102 of a coupling element 12 of a base station 10 from a rest position I, in which a fluid communication connection of the coupling element 12 with the cleaning apparatus 40 is prevented, to a coupling position Ill, in which the coupling element 12 is arranged on the cleaning apparatus 40, is provided, so that an emptying of the dirt space 41 via the coupling element 12 in the coupling position Ill is enabled. In coupling position Ill, dirt is then transported 103 from the dirt space 41 of the cleaning apparatus 40 via the coupling element 12, in particular wherein the dirt is sucked out of the dirt space 41.

The above explanation of the embodiments describes the present invention exclusively in the context of examples. Of course, individual features of the embodiments can be freely combined with each other, if technically reasonable, without leaving the scope of the present invention.

### LIST OF REFERENCE SIGNS

1 cleaning system
10 base station
11 dirt path
12 coupling element
12.1 sealing contour
12.2 bearing element
13 coupling lock
11 housing element
15 docking area
16 counter stop surface
17 collection space (for dirt)
20 drive unit
21 detection device
22 holding element
23 link guide
23.1 guide element
24 linear drive
25 swiveling drive
26 lever gear
26.1 lever element
27 feedback element
27.1 u-shaped slot
27.2 spring element
30 control unit
31 detection device
40 cleaning apparatus
41 dirt space (from 40)
42 stop surface
43 emptying interface
44 emptying opening
45 closing element
100 method
101 positioning from 40
102 moving from 12
103 removing of dirt
200 sequence of movement
201 first movement section
202 second movement section
I rest position
II intermediate position
III coupling position
V closing position
O opening position

1. A base station for stationary emptying of a dirt space of a mobile cleaning apparatus, comprising
a dirt path through which dirt can be transported out of the dirt space of the cleaning apparatus,
wherein a path input of the dirt path is formed by a coupling element which can be coupled to the cleaning apparatus for emptying the dirt space,
wherein
a drive unit is provided, by means of which the coupling element can be moved from a rest position, in which emptying of the dirt space via the coupling element is prevented, into a coupling position, in which the coupling element is arranged on the cleaning apparatus, so that emptying of the dirt space via the coupling element is enabled.

2. The base station according to claim 1,
wherein
the drive unit is designed to move the coupling element from the rest position until the coupling element is placed on the cleaning apparatus in the coupling position when the cleaning apparatus is positioned in a docking area.

3. The base station according to claim 1,
wherein
the drive unit comprises a detection device for recognizing the coupling position.

4. The base station according to claim 1,
wherein
a coupling lock is provided, by means of which the coupling element can be at least partially closed in the rest position.

5. The base station according to claim 1,
wherein
at least the drive unit comprises a holding element by means of which the movement of the coupling element can be limited if the coupling position remains unreached after a predetermined movement of the coupling element or the drive unit comprises a link guide through which the coupling element can be guided from the rest position to the coupling position.

6. The base station according to claim 1,
wherein
at least the drive unit comprises at least one linear drive for linearly moving the coupling element or at least one swiveling drive for carrying out a swiveling movement of the coupling element.

7. The base station according to claim 1,
wherein
at least the drive unit comprises a lever gear through which the coupling element can be guided from the rest position to the coupling position or a housing element is provided, through which a docking area is formed, in which the cleaning apparatus can be positioned in order to enable a coupling with the coupling element.

8. The base station according to claim 1,
wherein
at least the coupling element is arranged in such a way that, when the base station is used as intended, the coupling element is placed in the coupling position on an upper surface of the cleaning apparatus or the coupling element comprises a counter stop surface with which the coupling element can be placed in the coupling position on a stop surface of the cleaning apparatus.

9. The base station according to claim 1,
wherein
the drive unit is designed to move the coupling element from the rest position to the coupling position in a sequence of movement having at least two movement sections which differ at least partially in a direction of movement of the coupling element.

10. The base station according to claim 1,
wherein
the drive unit is designed to open an emptying interface of the cleaning apparatus in a first movement section of the coupling element and to move the coupling element in the direction of the emptying interface in a second movement section.

11. The base station according to claim 1,
wherein
the drive unit comprises a feedback element by means of which the coupling element is preloaded in the coupling position into at least the rest position or an intermediate position.

12. The base station according to claim 1,
wherein
the coupling element is rotatably mounted on a bearing element and comprises a circular arc-shaped sealing contour which enables the dust path to be sealed when the coupling element is rotated about the bearing element.

13. A cleaning system comprising
a mobile cleaning apparatus with a dirt space for receiving dirt during a cleaning process of the cleaning apparatus, and
a base station for stationary emptying of the dirt space of the cleaning apparatus, wherein the base station comprises a dirt path through which dirt can be transported out of the cleaning apparatus,
wherein a path input of the dirt path is formed by a coupling element which can be coupled to the cleaning apparatus for emptying of the dirt space,
wherein
the base station comprises a drive unit, by means of which the coupling element can be moved from a rest position, in which emptying of the dirt space via the coupling element is prevented, to a coupling position, in which the coupling element is arranged on the cleaning apparatus, so that emptying of the dirt space via the coupling element is enabled.

14. The cleaning system according to claim 13,
wherein
the cleaning apparatus comprises an emptying interface with a stop surface in which an emptying opening is formed so that the coupling element of the base station can be placed on the stop surface.

15. The cleaning system according to claim 13,
wherein
the cleaning apparatus comprises a closing element for closing the emptying interface, wherein the closing element can be moved from a closing position in which the emptying interface is at least partially closed by the closing element, to an opening position, in which the coupling element can be brought into fluid communication connection with the dirt space of the cleaning apparatus.

16. A method for stationary emptying of a dirt space of a mobile cleaning apparatus comprising the following steps:
Positioning of the cleaning apparatus at a base station,
Moving a coupling element from a rest position, in which a fluid communication connection of the coupling element with the cleaning apparatus is prevented, into a coupling position, in which the coupling element is arranged on the cleaning apparatus, so that emptying of the dirt space via the coupling element is enabled,
Removing dirt from the dirt space of the cleaning apparatus via the coupling element.

17. The method according to claim 16,
wherein
the cleaning apparatus is positioned in a docking area during positioning and the coupling element is moved until the coupling element is placed on the cleaning apparatus in the coupling position.

18. The method according to claim 16,
wherein
the moving of the coupling element from the rest position into the coupling position comprises a sequence of movement with at least two movement sections which differ at least partially in a direction of movement of the coupling element.

19. The method according to claim 16,
wherein
when the coupling element is moved in a first movement section of the coupling element, an emptying interface of the cleaning apparatus is opened and, in a second movement section, the coupling element is moved in the direction of the emptying interface.

20. The method according to claim 16,
wherein
at least the sequence of movement comprises at least one linear movement or at least one swiveling movement.
